(19) United States
(12) Patent Application Publication
(10) Pub. No.: US 2010/0057915 A1
(43) Pub. Date: Mar. 4, 2010

(54) Method and system for distributing applications

(75) Inventors: Karlheinz Dorn, Kalchreuth (DE); Vladyslav Ukis, Numberg (DE)

Correspondence Address: HARNESS, DICKEY & PIERCE, P.L.C., P.O.BOX 8910, RESTON, VA, 20195, US

(73) Assignee: Siemens Aktiengesellschaft

(21) Appl. No.: 12/461,907

(22) Filed: Aug. 27, 2009

(30) Foreign Application Priority Data
Aug. 28, 2008 (DE) 10 2008 044 843.5

(51) Int. Cl. G06F 15/16

(52) U.S. Cl. 709/226

(57) ABSTRACT

In a data processing network there exist at least two applications which are different from one another in terms of the volumes of data that are to be processed. In at least one embodiment, each application has a multilayer structure and individual layers of the applications are distributed over different hardware resources, specifically at least one local data processing unit and at least one remote data processing unit, in such a way that the number of layers installed on the local data processing unit as a proportion of the total number of layers making up the respective application is less in the case of that application which is provided for processing the greater volume of data than in the case of the application which is provided for processing the smaller volume of data.

### PRIORITY STATEMENT

The present application hereby claims priority under 35 U.S.C. §119 on German patent application number DE 10 2008 044 843.5 filed Aug. 28, 2008, the entire contents of which are hereby incorporated herein by reference.

### FIELD

At least one embodiment of the invention generally relates to a method and/or a system for distributing applications in a data processing network, in particular in a data processing network of a medical facility.

### BACKGROUND

A method for developing and executing at least one application as a function of a deployment environment is known from DE 10 2006 051 189 A1, the entire contents of which are incorporated herein by reference. Within the scope of the method, various deployment scenarios can come into effect, specifically thin client, rich thin client, rich client, adaptive client, fat client and web service. The applications are characterized by an n-layered structure and have a presentation layer for presenting information and for user interactions, a business process layer, which includes different business process logic modules, and a controller layer. In the case of a rich thin client, the controller layer can be configured in two parts or, as the case may be, as network functionality, thereby reducing the requirements placed on the hardware of a target computer, since many computationally intensive operations can be executed on a powerful computer that is shared by a plurality of users.

The different layers in the software architecture system known from DE 10 2006 051 189 A1 are preferably programmed independently of the deployment strategy. The flexible application architecture, which can be downloaded in accordance with requirements and deployment environment, identifies in which scenario an application is currently deployed. The modules of the application, for example their layers, are loaded and arranged in such a way that their current deployment environment remains “hidden” from the application or, as the case may be, does not have to be taken into account during the programming and/or at program start time.

Frequently employed terms for layers of a system architecture are “model”, “view” and “controller”, also referred to in summary as MVC software patterns. In this connection reference is made to DE 196 25 841 A1, the entire contents of which are incorporated herein by reference, which relates to a medical system architecture. Reference is also made to DE 10 2005 010 405 A1, the entire contents of which are incorporated herein by reference, which relates to a system arrangement and a method for automated application development comprising user prompting.

PACS (Picture Archiving and Communication System) systems are increasingly being deployed in hospitals. Potential applications for a PACS systems are disclosed in DE 10 2006 033 861 A1, for example, the entire contents of which are incorporated herein by reference. PACS systems are basically suited for processing any types of image data that is present in digital form. Such systems include, for example, computed tomography scanners, magnetic resonance equipment, digital X-ray machines or digital ultrasound devices. The fundamental problem addressed in DE 10 2006 033 861 A1 is the increasing volume of data that has to be managed in medical data processing networks. In a data network having a multiplicity of network nodes the aim is to solve this problem with the aid of three interlinked management processes. In this arrangement there is a first management process for buffering image data, a second management process for archiving the image data and a third management process for loading the image data, as disclosed in detail in DE 10 2006 033 861 A1. The overall object of this solution is to enable efficient management of medical image data.

### SUMMARY

In at least one embodiment of the invention, the performance of data processing systems that operate with multilayered applications is increased, in particular with regard to limited network resources, compared with the prior art.

In at least one embodiment of the invention, a method is disclosed for distributing applications in a data processing network and a system, embodied for distributing applications, is also disclosed. Advantages and embodiments explained hereinbelow in connection with the method also apply analogously to the apparatus, which is to say the system according to at least one embodiment of the invention, and vice versa.

In a data processing network implementing at least one embodiment of the method, in particular in a hospital, there exist at least two applications which are different from one another in terms of the volumes of data that need to be processed. Each application has a multilayer structure, with individual layers of the applications being distributed automatically over different hardware resources, specifically at least one local data processing unit and at least one remote data processing unit, in such a way that the number of layers installed on the local data processing unit as a proportion of the total number of layers making up the respective application is less in the case of that application which is provided for processing the greater volume of data than in the case of the application which is provided for processing the smaller volume of data.

At least one embodiment of the invention proceeds on the basis of the consideration that the fundamentally different handling of 2D data on the one hand and 3D data on the other hand constitutes a suitable starting point for improving efficiency in medical data processing systems. In general, applications that process three-dimensional image data (3D data) impose significantly higher requirements in terms of data transfer than 2D applications. In a system including a plurality of local data processing devices and at least one remote, central data processing unit it therefore appears advantageous to process a maximally large part of the 3D data locally in order not to place too heavy a load on the network, while a greater proportion of the 2D data, which is significantly smaller in size than the 3D data, could be processed centrally and thus transferred more frequently over the network. This would mean that a 2D application structured into multiple layers, in other words an application provided for processing a relatively small volume of data, has a smaller proportion of layers installed locally compared to a 3D application.

It has, however, become apparent that this consideration has not given due attention to the different character of data processing processes that relate to medical 3D data on the one hand and methods for processing two-dimensional data (2D data) acquired using medical imaging devices on the other hand. While it is true that the volume of 3D data is substantially greater than the volume of 2D data, the user nonetheless interacts with 2D applications typically very much more than with 3D applications, as is summarized in tabular form below:

TABLE 1
Differences between 2D and 3D applications

| | 2D application | 3D application |
|---|---|---|
| High interactive activity | Yes | No |
| Large data volumes | No | Yes |

Based on the knowledge outlined above, according to at least one embodiment of the inventive method, the application that has the greater volume of data to process, which is to say in particular the 3D application, will be executed to a lesser extent locally than the application that is provided for processing comparatively small data volumes, in particular for processing 2D data. In an example embodiment, all layers of the 2D application are executed locally, while at least some of the layers of the 3D application are executed centrally.

The 3D data is preferably processed in uncompressed form, while the 2D data is preferably processed in compressed form, compressed by a factor of ten, for example. Typically, the volumes of 2D data amount to a few megabytes and the 3D data to several gigabytes.

In an example embodiment each application comprises a presentation layer, a business process layer and a controller layer. The application provided for processing the smaller volume of data, in particular the 2D data, preferably forms a rich client configuration. In this case the presentation layer (V=View), the business process layer (M=Model) and the controller layer (C=Controller) are installed together on a single computer. The application provided for processing the larger volume of data, in particular the 3D data, preferably forms a rich thin client configuration. In the case of this latter configuration the layers V and C are installed on a local computer that executes the application, while the layer M is installed centrally, which is to say on a remote computer.

The data processing network embodied for carrying out the method preferably has a plurality of regions which are different from one another in terms of maximum data transfer rates. In this case the highest attainable data transfer rate within the data processing network is preferably at least 100 times, for example 1000 times, the lowest attainable data transfer rate within the data processing network. The region having the highest attainable data transfer rate represents the central region of the data processing network; the region having the lowest attainable data transfer rate represents the outermost region of the data processing network.

An advantage of at least one embodiment of the invention lies in particular in the fact that the specific characteristics of 2D and 3D data processing in the medical engineering field are taken into account in that a higher proportion of the 2D data processing is performed on local data processing devices than the 3D data processing. Preferably the 2D data processing is performed in a rich client configuration and the 3D data processing is performed in the same network in a rich thin client configuration.

### BRIEF DESCRIPTION OF THE DRAWINGS

An example embodiment of the invention is explained in more detail below with reference to a drawing, in which:

FIG. 1 shows in a symbolic representation main features of a medical data processing system configured for different applications,

FIG. 2 shows the basic structure of a 2D application having a rich client structure,

FIG. 3 shows the basic structure of a 3D application having a rich thin client structure,

FIG. 4 shows a programming interface provided for the development of the applications, and

FIG. 5 shows the basic partitioning of the data processing system into different regions differing from one another, inter alia, in terms of maximum data transfer rate.

### DETAILED DESCRIPTION OF THE EXAMPLE EMBODIMENTS

Various example embodiments will now be described more fully with reference to the accompanying drawings in which only some example embodiments are shown. Specific structural and functional details disclosed herein are merely representative for purposes of describing example embodiments. The present invention, however, may be embodied in many alternate forms and should not be construed as limited to only the example embodiments set forth herein.

Accordingly, while example embodiments of the invention are capable of various modifications and alternative forms, embodiments thereof are shown by way of example in the drawings and will herein be described in detail. It should be understood, however, that there is no intent to limit example embodiments of the present invention to the particular forms disclosed. On the contrary, example embodiments are to cover all modifications, equivalents, and alternatives falling within the scope of the invention. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments of the present invention. As used herein, the term “and/or,” includes any and all combinations of one or more of the associated listed items.

It will be understood that when an element is referred to as being “connected,” or “coupled,” to another element, it can be directly connected or coupled to the other element or intervening elements may be present. In contrast, when an element is referred to as being “directly connected,” or “directly coupled,” to another element, there are no intervening elements present. Other words used to describe the relationship between elements should be interpreted in a like fashion (e.g., “between,” versus “directly between,” “adjacent,” versus “directly adjacent,” etc.).

The terminology used herein is for the purpose of describing particular embodiments only and is not intended to be limiting of example embodiments of the invention. As used herein, the singular forms “a,” “an,” and “the,” are intended to include the plural forms as well, unless the context clearly indicates otherwise. As used herein, the terms “and/or” and “at least one of” include any and all combinations of one or more of the associated listed items. It will be further understood that the terms “comprises,” “comprising,” “includes,” and/or “including,” when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Spatially relative terms, such as “beneath”, “below”, “lower”, “above”, “upper”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, term such as “below” can encompass both an orientation of above and below. The device may be otherwise oriented (rotated 90 degrees or at other orientations) and the spatially relative descriptors used herein are interpreted accordingly.

Although the terms first, second, etc. may be used herein to describe various elements, components, regions, layers and/or sections, it should be understood that these elements, components, regions, layers and/or sections should not be limited by these terms. These terms are used only to distinguish one element, component, region, layer, or section from another region, layer, or section. Thus, a first element, component, region, layer, or section discussed below could be termed a second element, component, region, layer, or section without departing from the teachings of the present invention.

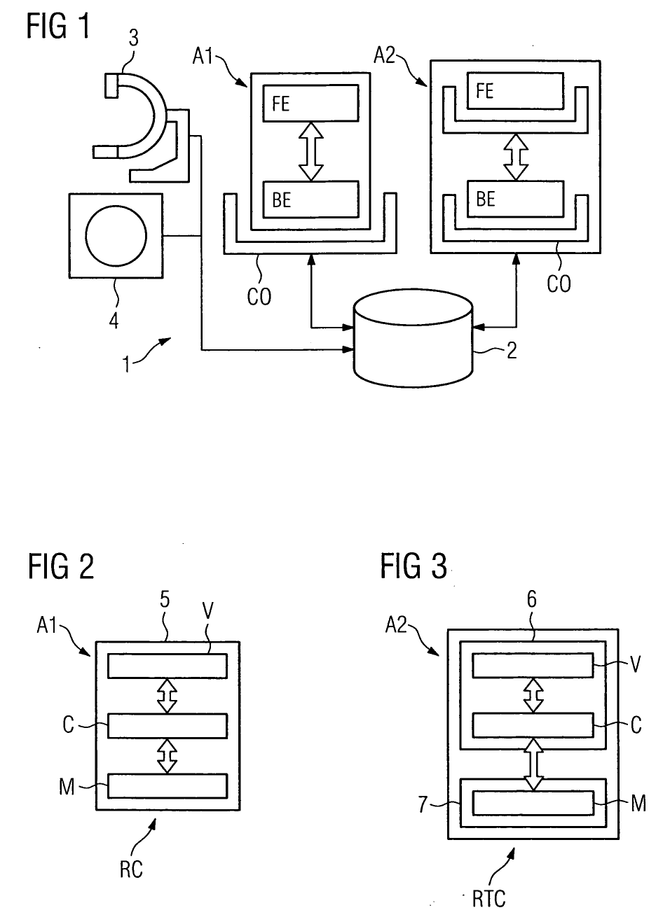

A medical data processing network 1 shown in a symbolic representation in FIG. 1 comprises as its central component a picture archiving and communication system (PACS) 2. The PACS system 2 serves for storing and processing two-dimensional and three-dimensional image data that has been acquired by means of imaging diagnostic devices 3,4, for example an X-ray machine 3 and a computed tomography scanner 4. Equally, a magnetic resonance device, an angiography device or a digital ultrasound device, for example, can be linked for data communication purposes to the PACS system 2 forming a central archive and hence to the data processing network 1. There is no restriction on the number of diagnostic devices 3,4 integrated into the data processing network 1 or linked thereto.

The 2D and 3D image data stored in the PACS system 2 is accessed by two applications A1,A2, the application A1 being provided for processing two-dimensional image data (2D data) and the application A2 for processing three-dimensional image data (3D data). Each application A1,A2 has a frontend FE and a backend BE. In the case of the 2D application A1, frontend FE and backend BE are loaded into a common container CO, also referred to as a generic container. In the case of the 3D application A2, in contrast thereto, separate containers CO are provided for the frontend FE and the backend BE. These different configurations are shown in finer detail in FIGS. 2 and 3:

Both the application A1 and the application A2 comprise three layers, specifically a presentation layer V (View), a business process layer M (Model) and a controller layer C (Control), and consequently form what is termed an MVC pattern. The layer V comprises the presentation logic of the application A1,A2, including buttons, selection boxes and image segments. The object of the layer M, in other words the model, is the business process logic of the application A1,A2, including the loading, modifying and storing of data. The layer C, in other words the controller, is embodied for registering user actions originated in the view, the clicking of a button for example, and transferring them to the model for further processing. Overall this produces a decoupling which ensures that the development of the business process logic is independent of the presentation logic and different types of presentation (Views) can be combined with the same business process logic (Model).

All layers M,V,C of the application A1 provided for processing two-dimensional data are executed on a single, local data processing unit 5, generally referred to as a hardware resource. This configuration is referred to as a rich client RC.

The application A2 provided for processing three-dimensional data is distributed over a plurality of hardware resources 6,7 as follows: The layers V,C are executed on a first physical machine, a local data processing unit 6, while the model M, as the third layer responsible for the actual image data processing, is installed on a remote, central data processing unit 7. This configuration is referred to as a rich thin client RTC.

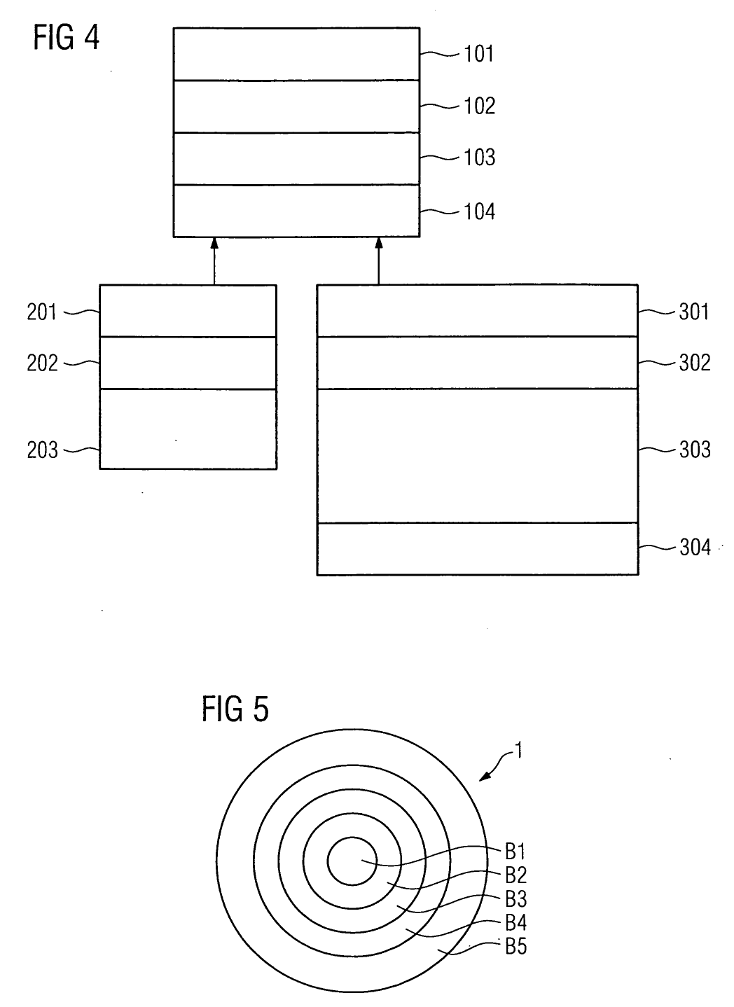

The frontend FE according to FIG. 1 corresponds to the presentation layer V according to FIGS. 3 and 4. The following is an example of a frontend configuration:

```
<configuration>
    <GenCmdConfigData>
        <ClientChannels>
            <GenCmdClientConfigData>
                <ChannelName>TestChannel2</ChannelName>
                <ApplicationName>genCmdTest</ApplicationName>
                <Protocol>Auto</Protocol>
                <Format>Auto</Format>
                <PortRangeMax>0</PortRangeMax>
                <PortRangeMin>0</PortRangeMin>
                <StdCommandFlags>CacheForFurtherOfflineUse<
                /StdCommandFlags>
                <PeerActivationData>
                    <Provider>MzAssembly</Provider>
                    <Type>AssemblyLoadActivator</Type>
                    <AssemblyActivatorType>MYTYPE</AssemblyActivatorType>
                    <CustomActivationData>any string</CustomActivationData>
                    <SingletonActivator>true</SingletonActivator>
                    <Timout sec>90</Timout sec>
                    <PeerSelectData>
                        <PeerSelectData />
                    </PeerSelectData>
                </PeerActivationData>
            <GenCmdClientConfigData>
        <ClientChannels>
    <GenCmdConfigData>
</configuration>
```

The backend BE according to FIG. 1 corresponds to the business process layer M according to FIGS. 3 and 4. The controller C not shown separately in FIG. 1 is implemented by means of a special configurable communication component. The following is an example of a backend configuration:

```
<configuration>
    <GenCmdConfigData>
        <ServerChannels>
            <GenCmdServerConfigData>
                <ChannelName>Test.*</ChannelName>
                <ApplicationName>genCmdTest</ApplicationName>
                <Protocol>TCP</Protocol>
                <Format>DataContract</Format>
                <PortRangeMax>911</PortRangeMax>
                <PortRangeMin>914</PortRangeMin>
                <ListenAddress>127.0.0.1</ListenAddress>
                <serverFlags>0</serverFlags>
            </GenCmdServerConfigData>
        </ServerChannels>
    <GenCmdConfigData>
</configuration>
```

In this configuration the fifth line (“<ChannelName . . . ”) in each case should be pointed out in particular, this being of particular importance in terms of the flexibility of the communication: Abstract string-based communication channels are defined via which the assignment of a frontend FE and backend BE to an application A1,A2 takes place. Only channel names are used by the developers of the applications A1,A2. This abstraction ensures that the code of the applications A1,A2 can be used independently of the physical deployment of their layers M,V,C, in other words of the software distribution within the data processing network 1. In this way good foundations are laid for particularly rapid application development.

FIG. 4 shows in exemplary form programming interfaces which can be used by application developers (API—Application Programming Interface). By defining specific communication interfaces it is possible to decide on the distribution of the layers M,V,C over individual hardware resources 5,6,7 only after the development of the applications A1,A2, and possibly also of any other applications. The meaning of the individual rows in FIG. 4 is explained by the following legend:

101 ICommunication (from syngo.Common.Core)

102 CommandPattern:string
EventPattern:string

103 sendEvent(string)

104 <<event>>ATEvent

201 ICommunicationClient (from syngo.Common.Core)

202 Execute( )
InitClientCommandChannel( )

203 <<event>>CommandReply
<<event>>ServerConnection
LostEvent

301 ICommunicationServer (from syngo.Common.Core)

302 ExceptionHandler:CommandExeptionHookCallback

303 InitCommandExecuteHandler( )
RegisterExecutionCallback( )
RegisterTypedExecutionCallback( )
UnRegisterExecutionCallback( )
UnRegisterTypedExecutionCallback( )

304 <<event>>ClientConnectionLostEvent
<<event>>CommandExecute

The non-uniform data transfer rates provided in the data processing network 1 play a particular role in the distribution of the layers M,V,C of the different applications A1,A2 over the hardware resources 5,6,7. The number of available data processing units is in fact considerably greater than according to the greatly simplified FIGS. 1 to 3. The structure of the data processing network 1 can be described, as depicted in FIG. 5, as a shell model having nested regions B1 . . . B5.

The regions B1 . . . B5 shown symbolically in FIG. 5 have the following characteristics:

TABLE 2
Regions of the data processing network

| | | Data transfer |
|---|---|---|
| Region | Type of image data | rate |
| B1 (“Modalities”) | 3D | 1000 Mbps |
| B2 (“Radiology”) | 3D | 100 Mbps |
| B3 (“Picture Center”) | 3D | 10 Mbps |
| B4 (“Clinician”) | 2D | 1 Mbps |
| B5 (“Home Office”) | 2D | 1 Mbps |

The diagnostic devices 3,4 provided for acquiring image data, also referred to as modalities, are located in the central region B1 of the data processing network 1. A relatively small number of people work in this region compared with the total number of people using the PACS 2. 3D viewing applications, such as the application A2, are deployed in the region B1. An adequate network bandwidth of 1000 Mbps is available for that purpose. The 3D data that is to be processed in the region B1 is typically in the gigabyte range in terms of its size.

Like the central region B1, the two next-outer regions B2,B3 are also provided for processing 3D data. In said regions B2,B3 the network bandwidth is reduced by a factor of 10 in each case compared to the next-inner region B1,B2. The two outermost regions B4,B5, finally, have a uniform network bandwidth of 1 Mbps. A higher number of people are active in said regions compared to the inner regions B1,B2,B3, although provision is made only for the processing of 2D data. As already explained hereinbefore, however, it is precisely during the processing of 2D data that user interactions which subject the data processing network 1 to load occur with particular frequency. Allowance is made for this factor by the implementation of the 2D application A1 as a rich client, whereas the 3D application A2 is implemented as a rich thin client. In comparison with systems in which 2D and 3D data are processed uniformly either using rich clients or using rich thin clients, this means a considerable time saving for the users of the data processing network 1.

The patent claims filed with the application are formulation proposals without prejudice for obtaining more extensive patent protection. The applicant reserves the right to claim even further combinations of features previously disclosed only in the description and/or drawings.

The example embodiment or each example embodiment should not be understood as a restriction of the invention. Rather, numerous variations and modifications are possible in the context of the present disclosure, in particular those variants and combinations which can be inferred by the person skilled in the art with regard to achieving the object for example by combination or modification of individual features or elements or method steps that are described in connection with the general or specific part of the description and are contained in the claims and/or the drawings, and, by way of combinable features, lead to a new subject matter or to new method steps or sequences of method steps, including insofar as they concern production, testing and operating methods.

References back that are used in dependent claims indicate the further embodiment of the subject matter of the main claim by way of the features of the respective dependent claim; they should not be understood as dispensing with obtaining independent protection of the subject matter for the combinations of features in the referred-back dependent claims. Furthermore, with regard to interpreting the claims, where a feature is concretized in more specific detail in a subordinate claim, it should be assumed that such a restriction is not present in the respective preceding claims.

Since the subject matter of the dependent claims in relation to the prior art on the priority date may form separate and independent inventions, the applicant reserves the right to make them the subject matter of independent claims or divisional declarations. They may furthermore also contain independent inventions which have a configuration that is independent of the subject matters of the preceding dependent claims.

Further, elements and/or features of different example embodiments may be combined with each other and/or substituted for each other within the scope of this disclosure and appended claims.

Still further, any one of the above-described and other example features of the present invention may be embodied in the form of an apparatus, method, system, computer program, computer readable medium and computer program product. For example, of the aforementioned methods may be embodied in the form of a system or device, including, but not limited to, any of the structure for performing the methodology illustrated in the drawings.

Even further, any of the aforementioned methods may be embodied in the form of a program. The program may be stored on a computer readable medium and is adapted to perform any one of the aforementioned methods when run on a computer device (a device including a processor). Thus, the storage medium or computer readable medium, is adapted to store information and is adapted to interact with a data processing facility or computer device to execute the program of any of the above mentioned embodiments and/or to perform the method of any of the above mentioned embodiments.

The computer readable medium or storage medium may be a built-in medium installed inside a computer device main body or a removable medium arranged so that it can be separated from the computer device main body. Examples of the built-in medium include, but are not limited to, rewriteable non-volatile memories, such as ROMs and flash memories, and hard disks. Examples of the removable medium include, but are not limited to, optical storage media such as CD-ROMs and DVDs; magneto-optical storage media, such as MOs; magnetism storage media, including but not limited to floppy disks (trademark), cassette tapes, and removable hard disks; media with a built-in rewriteable non-volatile memory, including but not limited to memory cards; and media with a built-in ROM, including but not limited to ROM cassettes; etc. Furthermore, various information regarding stored images, for example, property information, may be stored in any other form, or it may be provided in other ways.

Example embodiments being thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. A method for distributing applications in a data processing network including at least two applications which are different from one another in terms of the volumes of data that are to be processed, each application including a multilayer structure, the method comprising:
distributing individual layers of the applications over different hardware resources of the data processing network such that a number of individual layers installed on a local data processing unit of the data processing network, as a proportion of a total number of individual layers making up a respective one of the applications, is relatively less for one of the applications which is provided for processing a relatively greater volume of data than another one of the applications which is provided for processing a relatively smaller volume of data.

2. The method as claimed in claim 1, wherein the one of the applications provided for processing the relatively greater volume of data is a 3D application.

3. The method as claimed in claim 2, wherein the 3D data is processed in uncompressed form.

4. The method as claimed in claim 1, wherein the another one of the applications provided for processing the relatively smaller volume of data is a 2D application.

5. The method as claimed in claim 4, wherein the 2D data is processed in compressed form.

6. A system for distributing applications, comprising:
at least one local data processing unit; and
at least one remote data processing unit, at least two multilayered applications being distributed over the at least one local data processing unit and at least one remote data processing unit, one of the at least two multilayered applications being provided for processing a relatively greater volume of data and another one of the at least two multilayered applications being provided for processing a relatively smaller volume of data, and wherein a number of layers of the at least two multilayered applications installed on the local data processing unit, as a proportion of a total number of layers making up the at least two multilayered applications, is relatively less for the one of the at least two multilayered applications provided for processing the relatively greater volume of data than the another one of the at least two multilayered applications provided for processing the relatively smaller volume of data.

7. The system as claimed in claim 6, wherein each of the at least two multilayered applications includes a presentation layer, a business process layer and a controller layer.

8. The system as claimed in claim 7, wherein the another one of the at least two multilayered applications provided for processing the relatively smaller volume of data forms a rich client configuration.

9. The system as claimed in claim 7, wherein the one of the at least two multilayered applications provided for processing the relatively greater volume of data forms a rich thin client configuration.

10. The system as claimed in claim 6, wherein the data processing network includes a plurality of regions which are different from one another in terms of maximum data transfer rates.

11. The system as claimed in claim 10, wherein the relatively highest attainable data transfer rate within the data processing network equals at least 100 times the relatively lowest attainable data transfer rate within the data processing network.

12. The system as claimed in claim 10, wherein at least one region of the data processing network is provided exclusively for processing 2D data, while at least one further region of the data processing network is provided for processing 2D and 3D data.

13. The system as claimed in claim 6, wherein the data processing network includes a central archive with which both the one of the at least two multilayered applications provided for processing a relatively greater volume of data and the another one of the at least two multilayered applications provided for processing a relatively smaller volume of data interact.

14. A method, comprising:
using of a system for processing medical image data, the system including
at least one local data processing unit, and
at least one remote data processing unit, at least two multilayered applications being distributed over the at least one local data processing unit and at least one remote data processing unit, one of the at least two multilayered applications being provided for processing a relatively greater volume of data and another one of the at least two multilayered applications being provided for processing a relatively smaller volume of data, and wherein a number of layers of the at least two multilayered applications installed on the local data processing unit, as a proportion of a total number of layers making up the at least two multilayered applications, is relatively less for the one of the at least two multilayered applications provided for processing the relatively greater volume of data than the another one of the at least two multilayered applications provided for processing the relatively smaller volume of data.

15. The method as claimed in claim 1, wherein the distributing of individual layers of the applications over different hardware resources, includes distributing of individual layers of the applications over at least one local data processing unit and at least one remote data processing unit.

16. The method as claimed in claim 2, wherein the another one of the applications provided for processing the relatively smaller volume of data is a 2D application.

17. The method as claimed in claim 16, wherein the 2D data is processed in compressed form.

18. The method as claimed in claim 3, wherein the another one of the applications provided for processing the relatively smaller volume of data is a 2D application.

19. The method as claimed in claim 18, wherein the 2D data is processed in compressed form.

20. The system as claimed in claim 8, wherein the one of the at least two multilayered applications provided for processing the relatively greater volume of data forms a rich thin client configuration.

21. The system as claimed in claim 11, wherein at least one region of the data processing network is provided exclusively for processing 2D data, while at least one further region of the data processing network is provided for processing 2D and 3D data.

22. A computer readable medium including program segments for, when executed on a computer device, causing the computer device to implement the method of claim 1.

23. A computer readable medium including program segments for, when executed on a computer device, causing the computer device to implement the method of claim 14.
